(19) United States
(12) Patent Application Publication
(10) Pub. No.: US 2023/0159098 A1
(43) Pub. Date: May 25, 2023

(54) Steering System

(71) Applicants: Hyundai Motor Company, Seoul (KR); Kia Corporation, Seoul (KR)

(72) Inventors: Sang Woo Hwang, Seoul (KR); Young II Sohn, Yongin-si (KR); Sehyun Chang, Suwon-si (KR); Min Jun Kim, Busan (KR)

(21) Appl. No.: 18/045,991

(22) Filed: Oct. 12, 2022

(30) Foreign Application Priority Data
Nov. 19, 2021 (KR) 10-2021-0160083

(51) Int. Cl. B62D 7/15

(52) U.S. Cl. CPC B62D 7/1509; B62D 7/159

(57) ABSTRACT

An embodiment is a steering system including an in-wheel motor disposed on a wheel of a vehicle and configured to turn the wheel, a strut arm connecting the in-wheel motor and a vehicle body, a joint clutch on the vehicle body and configured to engage or disengage the strut arm to allow or disallow the strut arm to pivot about the vehicle body, and a controller configured to control the in-wheel motor and the joint clutch.

### CROSS-REFERENCE TO RELATED APPLICATIONS

This application claims the benefit of Korean Patent Application No. 10-2021-0160083, filed on Nov. 19, 2021, which application is hereby incorporated herein by reference.

### TECHNICAL FIELD

The present disclosure relates to a vehicle steering system and a method of controlling the same.

### BACKGROUND

Recently, electric vehicles, fuel cell vehicles, and the like which are driven using an electric motor are receiving a lot of attention in terms of eco-friendliness. Such a vehicle is provided with one or two large motors.

On the other hand, in-wheel motors are small motors disposed on hubs of wheels, respectively, thereby enabling each of the wheels to be controlled independently. Vehicles provided with in-wheel motors have a simpler drive system compared to vehicles provided with large motors, and thus a space may be easily ensured. In addition, since wheels are controlled independently, the torque of each of the wheels can be adjusted independently, thereby improving the movement performance of the vehicle.

In addition, it is difficult to realize vehicle steering at a large angle of ±90° in existing axle type vehicles, and an in-wheel motor system is generally used to realize vehicle steering at a large angle of ±90°. For steering at a large angle, an actuator for steering is provided on a king pin shaft, and in order to reduce load applied to the actuator, the turning axis of the steering is set to be close to the axis of rotation of a tire. Nevertheless, large torque is necessary for the steering, and thus a large actuator is required. In this case, there are problems in that space utilization is reduced and weight and cost are increased due to the installation of additional parts.

The above information disclosed in this Background section is only for enhancement of understanding of the background of the disclosure and accordingly it may include information that does not form the prior art that is already known to a person of ordinary skill in the art.

Japanese Laid-Open Patent Application No. 2016-22756, published on Feb. 8, 2016, may include information related to the subject matter of the present disclosure.

### SUMMARY

The present disclosure has been made in an effort to solve the above-described problem associated with the related art, and an object of the present disclosure is to provide a steering system for independently driven wheels, wherein a steering actuator may be omitted.

The object of the present disclosure is not limited to the aforementioned object, and the other objects not mentioned may be clearly understood by those with ordinary skill in the art to which the present disclosure pertains (hereinafter ‘those skilled in the art’) from the following description.

The features of the present disclosure for achieving the object of the present disclosure, and performing the characteristic functions of the present disclosure to be described later are as follows below.

A steering system according to an embodiment of the present disclosure may include: an in-wheel motor disposed on a wheel of a vehicle and configured to turn the wheel; a strut arm connecting the in-wheel motor and a vehicle body; a joint clutch provided on the vehicle body and configured to engage or disengage the strut arm to allow or disallow the strut arm to pivot about the vehicle body; and a controller configured to control the in-wheel motor and the joint clutch.

According to the present disclosure, the steering system for independently driven wheels, wherein cost and weight may be reduced by omitting a steering actuator, and the method of controlling the same are provided.

The effect of the present disclosure is not limited to the aforementioned effect, and the other effects not mentioned may be clearly recognized by those skilled in the art from the following description.

### BRIEF DESCRIPTION OF THE DRAWINGS

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 illustrates a vehicle including a steering system according to the present disclosure;

FIG. 2 is an enlarged view of one of the wheels illustrated in FIG. 1;

FIG. 3 is a specific view of FIG. 2;

FIG. 4 is a flowchart illustrating a control process of a steering system according to an embodiment of the present disclosure; and

FIGS. 5A to 6B are views illustrating the principle of the steering system according to the present disclosure.

### DETAILED DESCRIPTION OF ILLUSTRATIVE EMBODIMENTS

Specific structural or functional descriptions presented in exemplary embodiments of the present disclosure are only exemplified for the purpose of describing the exemplary embodiments according to the concept of the present disclosure, and the exemplary embodiments according to the concept of the present disclosure may be carried out in various forms. Further, the exemplary embodiments should not be interpreted as being limited to the exemplary embodiments described in the present specification, and should be understood as including all modifications, equivalents, and substitutes included in the spirit and scope of the present disclosure.

Meanwhile, in the present disclosure, terms such as first and/or second may be used to describe various components, but the components are not limited to the terms. The terms are used only for the purpose of distinguishing one component from other components. For example, a first component may be referred to as a second component, and similarly, the second component may also be referred to as the first component, without departing from the scope according to the concept of the present disclosure.

When a component is referred to as being “connected” or “coupled” to another component, it should be understood that the components may be directly connected or coupled to each other, but still other component may also exist therebetween. On the other hand, when a component is referred to as being “directly connected to” or “in direct contact with” another component, it should be understood that there is no other component therebetween. Other expressions for describing the relationship between components, that is, expressions such as “between” and “directly between” or “adjacent to” and “directly adjacent to” should be also interpreted in the same manner.

Throughout the specification, the same reference numerals refer to the same elements. Meanwhile, the terms used in the present specification are for the purpose of describing the exemplary embodiments and are not intended to limit the present disclosure. In the present specification, the singular form also includes the plural form unless otherwise specified in the phrase. “Comprises” and/or “comprising” used in the specification specifies the presence of the mentioned component, step, operation, and/or element, and does not exclude the presence or the addition of one or more other components, steps, operations, and/or elements.

Hereinafter, the present disclosure will be described in detail with reference to the accompanying drawings.

Embodiments of the present disclosure relate to a vehicle steering system and a method of controlling the same, and more particularly, to a steering system for wheels that are independently controlled and a method of controlling the same.

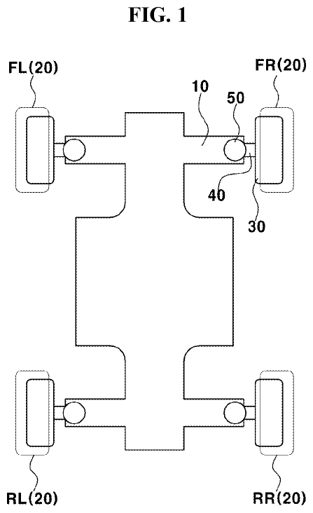

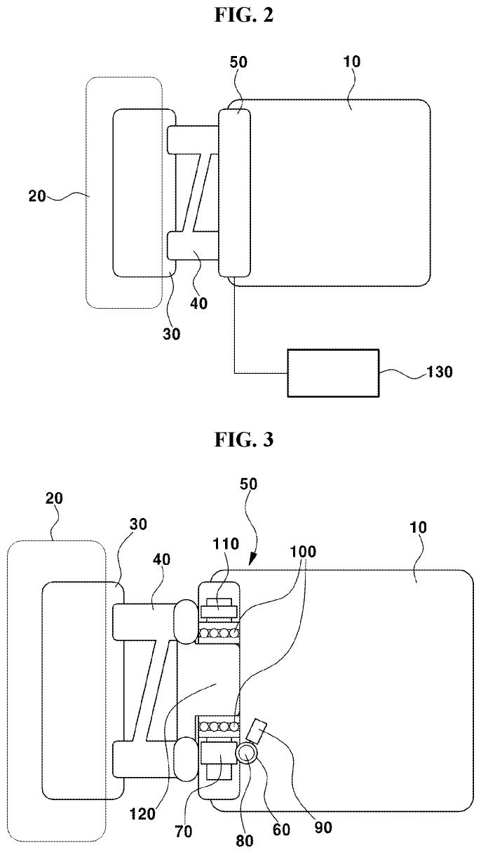

As illustrated in FIGS. 1 and 2, wheels 20 are coupled to corners of a vehicle body 10, respectively. The wheels 20 include a front left wheel FL, a front right wheel FR, a rear left wheel RL, and a rear right wheel RR.

Each of the wheels 20 is provided with an in-wheel motor 30. Thus, the turning of the each of the wheels 20 may be controlled independently of the other wheels by the drive of the in-wheel motor 30.

According to the present disclosure, the steering of each of the wheels 20 may be controlled respectively. Each of the wheels 20 may be turned to the range of about ±90° with respect to the normal position (e.g., normal position shown in FIG. 1). In this regard, a steering system according to an embodiment of the present disclosure includes a strut arm 40 and a joint clutch 50.

The strut arm 40 is equipped with a suspension device (not shown), and connects each of the wheels 20 to the vehicle 10. In an implementation, one side of the strut arm 40 is coupled to the in-wheel motor 30, and the other side of the strut arm 40 is coupled to the joint clutch 50 by a joint 120 provided on the vehicle 10.

The strut arm 40 is pivotably coupled to the joint clutch 50 by the joint 120. The joint 120 is fixed or unfixed by the joint clutch 50.

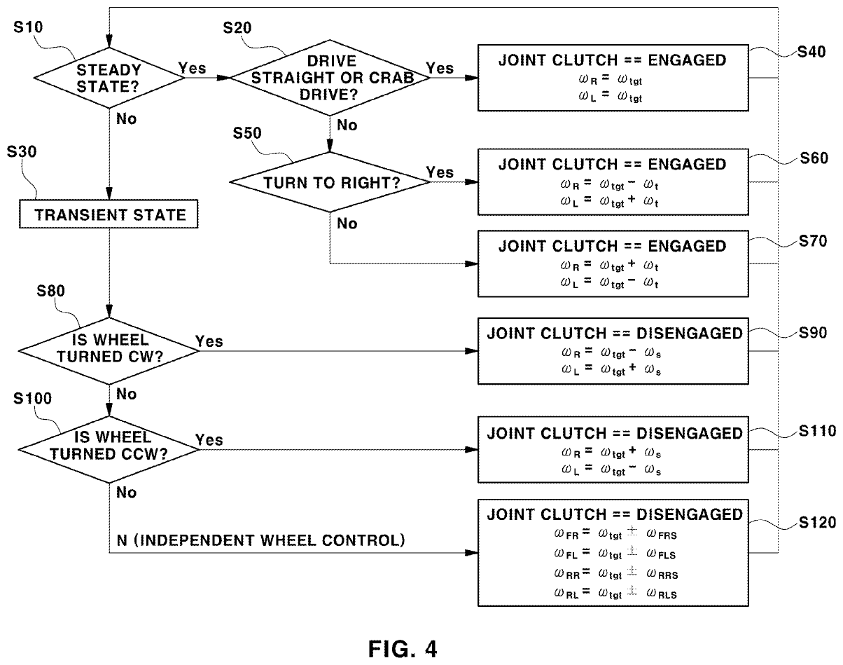

As illustrated in FIG. 3, the joint clutch 50 is coupled to the strut arm 40 and the joint 120, e.g., an R-joint. The joint clutch 50 coupled to the vehicle 10. The joint clutch 50 controls the pivoting of the joint 120. In this regard, according to an implementation of the present disclosure, the joint clutch 50 includes a worm drive 60 and 70 and a joint motor 80.

The worm drive 60 and 70 includes a worm 60 and a worm wheel 70. The worm 60 and the worm wheel 70 are configured to control the joint 120. Since the wheel 20 constantly applies torque to the joint clutch 50 during driving, the worm drive 60 and 70 are capable of self-locking (i.e., reverse rotation prevention). For example, the worm drive 60 and 70 can be self-locked from a predetermined lead angle. As a non-limiting example, the lead angle may be 4°. Thus, the worm drive 60 and 70 is configured to remove external force, i.e., torque input to the joint clutch 50 from the driven wheel 20.

The joint motor 80 provides rotational force to the worm drive 60 and 70. When the engaged worm drive 60 and 70 is disengaged, the joint motor 80 provides rotational force, by which the worm drive 60 and 70 is driven in the case of steering of the wheel 20. Here, since force applied to the worm drive 60 and 70 is mainly a reverse input from the wheel 20, it is only required for the joint motor 80 to provide a level of torque to disengage the joint clutch 50 and release the worm drive 60 and 70 in the case of steering. In addition, when the torque of the joint motor 80 is controlled, the steering angular velocity of the wheel 20 may be additionally controlled by the joint motor 80.

According to an embodiment of the present disclosure, a locker 90 is further included. In an implementation, the locker 90 is a solenoid locker. The locker 90 may exclude the possibility of unlocking of the self-locking of the worm 60 due to vibrations and prevent reverse rotation.

In an implementation, a thrust bearing 100 is disposed to support the pivoting of the joint 120 or the strut arm 40.

According to an implementation of the present disclosure, the steering system includes an angle sensor 110. The angle sensor 110 is disposed on each of the wheels 20, and configured to measure a turning angle of each of the wheels 20.

A controller 130 drives the joint motor 80. In an implementation, the controller 130 may adjust the torque of the joint motor 80. In addition, the controller 130 may receive information regarding the turning angle of each of the wheels 20 from the angle sensor 110, and may adjust the steering on the basis of the received information. In addition, the controller 130 may control the locking or unlocking of the locker 90.

The controller 130 is configured to be able to control each of the in-wheel motors 30. For example, the controller 130 may be configured to be able to communicate with the in-wheel motor 30 to control the operation of the in-wheel motor 30. Alternatively, the controller 130 may be configured to be able to directly control the in-wheel motor 30. In addition, the controller 130 may collect measurements of a steering angle sensor (not shown) of the steering wheel of the vehicle. In an implementation, the measurements of the steering angle sensor of the steering wheel may be angles input to a vehicle through the steering wheel by a vehicle driver.

According to the present disclosure, a steering actuator is omitted, and the steering is performed using force generated by a relative speed between the vehicle body and the wheel and a moment arm generated by spacing the center of turning of the wheel away from the center of a tire.

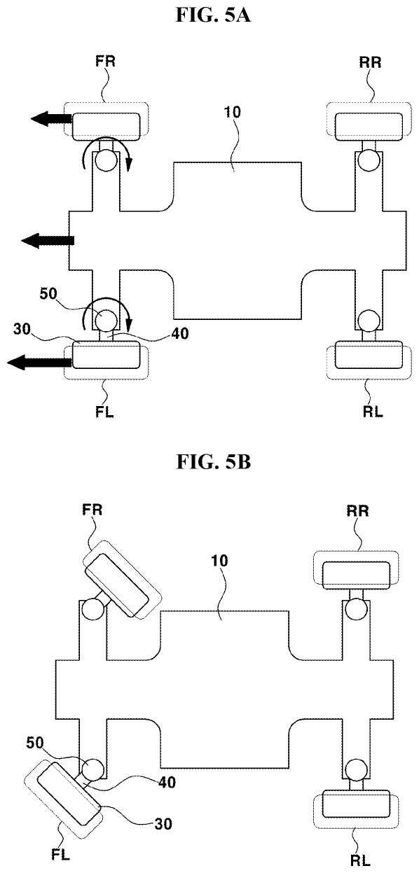

Referring to FIG. 4, a method of controlling a steering system according to some embodiments of the present disclosure is as follows.

First, the controller 130 receives whether or not the steering angle of the vehicle has been changed. Whether or not the steering angle of the vehicle has been changed may be determined by an input of the vehicle driver or on the basis of a steering command value of the vehicle. In the case of active steering, whether or not the steering angle of the vehicle has been changed by a steering command determined by an active steering system, i.e., a steering command of the vehicle, may be determined.

Specifically, the controller 130 determines whether or not a steering state is a normal state in S10. When the steering state is the normal state, step S20 is performed. When the steering state is not the normal state, the steering state is determined to be a transient state in S30. Herein, whether the steering state is the normal state or the transient state is determined according to whether or not the steering angle has been changed. When there has been no change in the steering angle over time, i.e., the steering angle has not been changed, the steering state is determined to be the normal state. When the steering angle has been changed, the steering state is determined to be the transient state. In addition, the control of the steering system may be performed differently according to the state.

The controller 130 may perform a steering control in response to a specific steering request from the driver.

In the normal state, the controller 130 determines whether the current state is a straight driving state or a crab driving state in S20. When the vehicle is in the straight driving state or the crab driving state on the basis of a current steering command of the vehicle, the controller 130 sets the joint clutch 50 in an engaged position in S40. In addition, the controller 130 drives respective in-wheel motors 30 by setting each of the angular velocity ω_{R} of the right wheel 20 and the angular velocity ω_{L} of the left wheel 20 to be target angular velocity ω_{tgt} in the same manner. A target angular velocity ω_{tgt} refers to an angular velocity by which a target vehicle speed is to be obtained.

When the controller 130 determines that the current state is neither the straight driving state nor the crab driving state in the normal state, the controller 130 determines whether or not the vehicle is turning to the right in S50. Here, although the determination of whether or not the vehicle is turning to the right is first taken as an example, determination of whether or not the vehicle is turning to the left may precede.

When it is determined that turning to the right is requested on the basis of the current steering command of the vehicle in the normal state, in S60, the controller 130 sets the joint clutch 50 in the engaged position and only changes the angular velocities of the wheels 20 differently from the straight driving in the above step S50. When the steering angle has not been changed as above, the joint clutch 50 is in a constantly engaged position. In addition, the angular velocity ω_{R} of the right wheel 20 and the angular velocity ω_{L} of the left wheel 20 are set, and the respective in-wheel motors 30 are driven using the set angular velocities ω_{R} and ω_{L}. That is, in the case of the right wheel 20, a difference angular velocity cot for a wheel speed difference during turning to the right is deducted from the target angular velocity ω_{tgt}. In contrast, in the case of the left wheel 20, the difference angular velocity ωₜ is added to the target angular velocity ω_{tgt}. That is, in the case of the turning to the right, the right wheel is rotated at a slower speed than the left wheel.

A case in which the turning to the left is requested in the normal state is contrary to the turning to the right. The controller 130 sets the joint clutch 50 in the engaged position and sets the angular velocity of the right wheel 20 and the angular velocity of the left wheel 20 in S70. That is, in the case of the left wheel 20, the difference angular velocity ωₜ is deducted from the target angular velocity ω_{tgt}, but, in the case of the right wheel 20, the difference angular velocity ωₜ is added to the target angular velocity ω_{tgt}.

In addition, in a case in which the steering state is the transient state instead of being the normal state in S30, when the steering angle is changing, the controller 130 determines whether or not there is a request to turn the wheels 20 in the clockwise direction CW on the basis of the current steering command of the vehicle in S80. In response to the request to turn in the clockwise direction CW, the controller 130 disengages the joint clutch 50 so that the wheel 20 can turn with respect to the joint 120. In addition, the angular velocities of the wheels 20 are set in S90. The respective in-wheel motors 30 are driven by setting the angular velocity ω_{R} of the right wheel 20 to be a value obtained by deducting a steering angular velocity cos that is an angular velocity for steering from the target angular velocity ω_{tgt} and the angular velocity ω_{L} of the left wheel 20 to be a value obtained by adding the steering angular velocity cos to the target angular velocity ω_{tgt}.

Similarly, when the wheel 20 is turned in the counterclockwise direction CCW in S100, the controller 130 controls the joint clutch 50 to be disengaged. In addition, the controller 130 sets the angular velocity ω_{R} of the right wheel 20 to be a value obtained by adding the steering angular velocity cos to the target angular velocity ω_{tgt} and the angular velocity ω_{L} of the left wheel 20 to be a value obtained by deducting the steering angular velocity cos from the target angular velocity ω_{tgt} in S110. Here, similarly, although the determination of whether or not the vehicle is turning in the clockwise direction CW is first performed as an example, determination of whether or not the vehicle is turning in the counterclockwise direction CCW may precede.

When the wheel 20 is not turned in the clockwise direction CW or the counterclockwise direction CCW even in the transient state, i.e., even if there has been a change in the steering angle, the controller 130 determines that the state to be a state in which the wheels are controlled independently. In the case of independent controlling of the wheels, the controller 130 controls the joint clutch 50 to be disengaged, and calculates the angular velocities ω_{FR}, ω_{FL}, ω_{RR}, and ω_{RL} of each of the wheels 20 by adding or deducting the angular velocities ω_{FRS}, ω_{FLS}, ω_{RRS}, and ω_{RLS} for the steering of the respective wheels 20 to or from the target angular velocity ω_{tgt} according to the target value in S120.

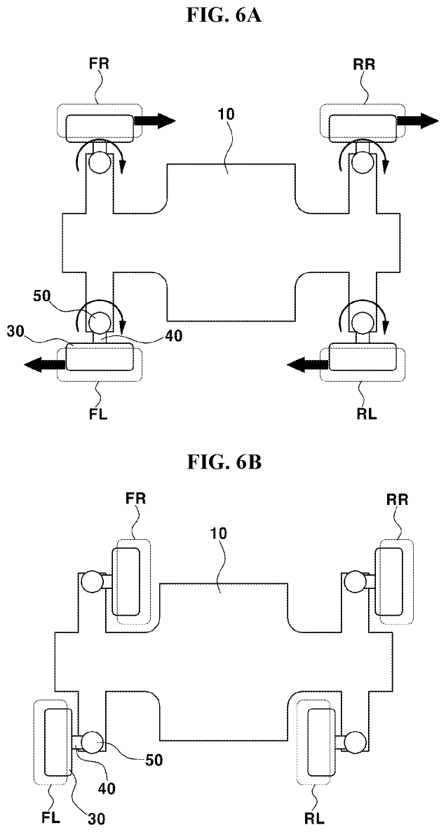

Referring to FIGS. 5A to 6B, some of the steering control by the steering system according to the present disclosure will be described.

Referring to FIG. 5A, in the transient state, i.e., during changing of the steering angle, when it is intended to turn the front wheels in the clockwise direction CW in order to turn right during the straight driving, the controller 130 engages the joint clutch 50. In an implementation, the controller 130 drives the worm drive 60 and 70 by rotating the joint motor 80. Then, the strut arm 40 is pivotable with respect to the joint 120. In addition, the controller 130 drives the in-wheel motor 30 of the right wheel with respect to the direction of forward movement of the vehicle so that the speed of the right wheel is less than the speed of the vehicle and the in-wheel motor 30 of the left wheel 20 with respect to the direction of forward movement of the vehicle so that the speed of the left wheel is faster than the speed of the vehicle. Arrows in FIG. 5A indicate different speeds. Then, as illustrated in FIG. 5B, due to the different relative speeds, the wheels 20 turn about the joints 120. Here, the joint clutches 50 are disengaged only when the wheels 20 are turned, and the joint clutches 50 are engaged to prevent turning when the wheels 20 are not to be turned, such as in the case of forward movement or the like.

According to the present disclosure, 90° steering of the wheel 20 may be performed. In particular, 90° steering of the wheel 20 may be performed by differently setting the turning direction of the left wheels and the turning direction of the right wheels at a stopped state of the vehicle. In an implementation, as illustrated in FIG. 6A, the steering may be performed by rotating the left wheels forward and the right wheels backward at the stopped state. In FIG. 6B, a state in which the vehicle is movable parallel to the right direction of the vehicle is illustrated. In order to form this state, the controller 130 disengages the joint clutch 50 by driving the joint motor 80 during the stopped state of the vehicle so that the steering of the wheels 20 is possible. That is, the wheel 20 may be turned about the joint 120 in order to disengage the joint clutch 50. In addition, the controller 130 drives the in-wheel motors 30 of the left wheels FL and RL so that the left wheels FL and RL rotate forward (i.e., vehicle forward movement) and the in-wheel motors 30 of the right wheels FR and RR so that the right wheels FR and RR rotate backward (i.e., vehicle backward movement). Consequently, as illustrated in FIG. 5B, the respective wheels 20 may be arranged to be parallel to the transverse direction of the vehicle.

Since the steering system according to the present disclosure is configured such that the steering motor can be omitted, weight and cost of the steering system can be reduced, and the steering system is advantageous in terms of space.

The aforementioned present disclosure is not limited by the aforementioned exemplary embodiments and the accompanying drawings, and it will be apparent to those skilled in the art that various substitutions, modifications, and changes may be made without departing the technical sprit of the present disclosure.

What is claimed is:

1. A steering system comprising:
an in-wheel motor disposed on a wheel of a vehicle and configured to turn the wheel;
a strut arm connecting the in-wheel motor and a vehicle body;
a joint clutch on the vehicle body and configured to engage or disengage the strut arm to allow or disallow the strut arm to pivot about the vehicle body; and
a controller configured to control the in-wheel motor and the joint clutch.

2. The steering system of claim 1, wherein the joint clutch comprises a worm drive configured to fix or unfix the strut arm.

3. The steering system of claim 2, wherein the joint clutch further comprises a joint motor, and the worm drive comprises:
a worm wheel configured to fix or unfix the strut arm; and
a worm configured to rotate the worm wheel using rotational force provided from the joint motor.

4. The steering system of claim 2, further comprising a locker configured to selectively fix the worm drive.

5. The steering system of claim 3, wherein the worm drive is configured to self-lock.

6. The steering system of claim 5, wherein the controller drives the joint motor when the joint clutch is disengaged.

7. The steering system of claim 1, wherein the joint clutch further comprises a thrust bearing configured to support pivoting of the strut arm.

8. The steering system of claim 1, further comprising a joint connecting the strut arm to the vehicle body, the joint configured to pivot the strut arm about the vehicle body, wherein the joint is engaged by the joint clutch to prevent the strut arm from pivoting and released by the joint clutch to allow the strut arm to pivot.

9. A method of controlling a steering system, the method comprising:
detecting, by the controller, whether or not a steering angle of a vehicle changes, the steering system of the vehicle comprising an in-wheel motor disposed on a wheel, a strut arm connecting the in-wheel motor and a vehicle body, a joint clutch on the vehicle body and coupled to the strut arm, and the controller configured to control the in-wheel motor and the joint clutch; and
engaging or disengaging, by the controller, the joint clutch depending on whether or not the steering angle of the vehicle changes, the engaging or disengaging of the joint clutch allowing or disallowing the strut arm to pivot about the vehicle body.

10. The method of claim 9, further comprising controlling, by the controller, the in-wheel motors so that at least some of the in-wheel motors provide different control outputs depending on whether or not the steering angle changes.

11. The method of claim 10, wherein the control output comprises at least one of a turning direction or a rotation speed of each of the wheels.

12. The method of claim 10, further comprising disengaging, by the controller, the joint clutch when the steering angle changes.

13. The method of claim 12, further comprising:
determining, by the controller, the turning direction of the vehicle in accordance with a current steering command of the vehicle; and
when the vehicle turns right, controlling, by the controller, the in-wheel motors of the right and left wheels so that the rotation speed of the right wheel is less than the rotation speed of the left wheel.

14. The method of claim 12, further comprising:
determining, by the controller, the turning direction of the vehicle in accordance with a current steering command of the vehicle; and
when the vehicle turns left, controlling, by the controller, the in-wheel motors of the right and left wheels so that the rotation speed of the left wheel is less than the rotation speed of the right wheel.

15. The method of claim 12, further comprising:
determining, by the controller, the turning direction of the vehicle in accordance with a current steering command of the vehicle; and
when the vehicle does not turn left or right, respectively controlling, by the controller, the rotation speeds of the wheels.

16. The method of claim 10, further comprising, when the steering angle does not change, engaging, by the controller, the joint clutch.

17. The method of claim 15, further comprising, when the vehicle is determined to be in a straight driving state or a crab driving state in accordance with a current steering command of the vehicle, controlling, by the controller, the in-wheel motors so that each of the in-wheel motors rotates at a set rotation speed.

18. The method of claim 15, further comprising, when the vehicle is determined to turn right in accordance with a current steering command of the vehicle, controlling, by the controller, the in-wheel motors of the right and left wheels so that the rotation speed of the right wheel is less than the rotation speed of the left wheel.

19. The method of claim 15, further comprising, when the vehicle is determined to turn left in accordance with a current steering command of the vehicle, controlling, by the controller, the in-wheel motors of the right and left wheels so that the rotation speed of the left wheel is less than the rotation speed of the right wheel.
